(19) United States
(12) Patent Application Publication
(10) Pub. No.: US 2014/0089806 A1
(43) Pub. Date: Mar. 27, 2014

(54) TECHNIQUES FOR ENHANCED CONTENT SEEK

(71) Applicants: John C. Weast, Portland, OR (US); Melissa O'Neill, Claremont, CA (US); Christopher R. Beavers, Bee Cave, TX (US); Richard S. Porczak, San Luis Obispo, CA (US); Dinh Tu R. Truong, Long Beach, CA (US); Jia-Shi Zhang, Camarillo, CA (US)

(72) Inventors: John C. Weast, Portland, OR (US); Melissa O'Neill, Claremont, CA (US); Christopher R. Beavers, Bee Cave, TX (US); Richard S. Porczak, San Luis Obispo, CA (US); Dinh Tu R. Truong, Long Beach, CA (US); Jia-Shi Zhang, Camarillo, CA (US)

(21) Appl. No.: 13/626,742

(22) Filed: Sep. 25, 2012

(51) Int. Cl. G06F 3/0481

(52) U.S. Cl. CPC G06F 3/0481
USPC 715/730

(57) ABSTRACT

Techniques for enhanced content seek are described. In one embodiment, for example, an apparatus may comprise a processor circuit and a content management module, and the content management module may be operative on the processor circuit to receive an instruction to initiate a seek presentation mode for a content item, determine content description information for the content item, and generate seek presentation information comprising the content description information. In this manner, an improved seek presentation may be realized that provides descriptive information regarding portions of content as a seek is being performed through those portions of content, such that a user may be better able to identify a point at which a desired location within the content has been reached. Other embodiments are described and claimed.

### BACKGROUND

While viewing playback of a content item on a content presentation device, a viewer may wish to initiate a seek presentation mode, such as a rewind or fast forward mode, in order to reach a particular point in the content item, to review or analyze particular elements of the content item, to advance past scenes that he does not wish to view, or for other reasons. However, when a content item is viewed in a seek presentation mode it may be more difficult for the viewer to maintain an understanding of the content being displayed. For example, when a content item is displayed in a rewind mode, the visual effects comprised within the content may be presented in an accelerated fashion and the corresponding audio may be omitted. As a result, it may be difficult for the viewer to determine, for example, when he has reached a particular scene, line of dialog, or plot development of interest. Accordingly, techniques for enhanced content seek may be desirable.

### BRIEF DESCRIPTION OF THE DRAWINGS

FIG. 1 illustrates one embodiment of an apparatus and one embodiment of a first system.

FIG. 2 illustrates one embodiment of a content description database.

FIG. 3 illustrates one embodiment of a content item presentation.

FIG. 4 illustrates one embodiment of a logic flow.

FIG. 5 illustrates one embodiment of a second system.

FIG. 6 illustrates one embodiment of a third system.

FIG. 7 illustrates one embodiment of a device.

### DETAILED DESCRIPTION

Various embodiments may be generally directed to techniques for enhanced content seek. In one embodiment, for example, an apparatus may comprise a processor circuit and a content management module, and the content management module may be operative on the processor circuit to receive an instruction to initiate a seek presentation mode for a content item, determine content description information for the content item, and generate seek presentation information comprising the content description information. In this manner, an improved seek presentation may be realized that provides descriptive information regarding portions of content as a seek is being performed through those portions of content, such that a user may be better able to identify a point at which a desired location within the content has been reached. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

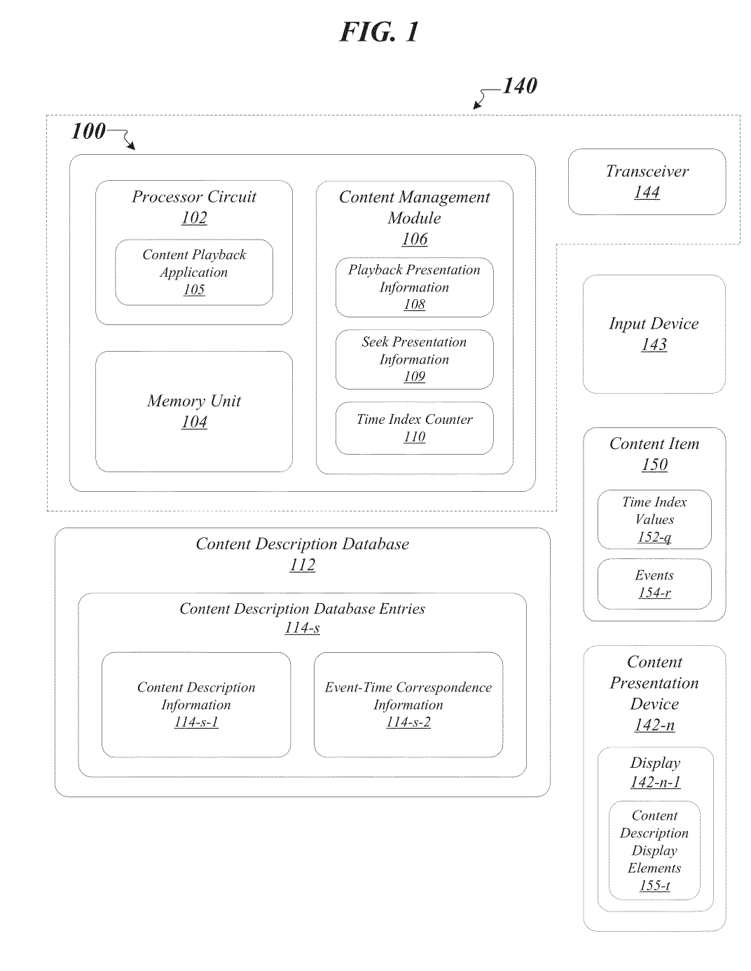

FIG. 1 illustrates a block diagram of an apparatus 100. As shown in FIG. 1, apparatus 100 comprises multiple elements including a processor circuit 102, a memory unit 104, and a content management module 106. The embodiments, however, are not limited to the type, number, or arrangement of elements shown in this figure.

In various embodiments, apparatus 100 may comprise processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 102 may be implemented as a general purpose processor, such as a processor made by Intel® Corporation, Santa Clara, Calif. The embodiments are not limited in this context.

In some embodiments, apparatus 100 may comprise or be arranged to communicatively couple with a memory unit 104. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 104 may be included on the same integrated circuit as processor circuit 102, or alternatively some portion or all of memory unit 104 may be disposed on an integrated circuit or other medium, for example a hard disk drive, that is external to the integrated circuit of processor circuit 102. Although memory unit 104 is comprised within apparatus 100 in FIG. 1, memory unit 104 may be external to apparatus 100 in some embodiments. The embodiments are not limited in this context.

In various embodiments, processor circuit 102 may be operable to execute a content presentation application 105. Content presentation application 105 may comprise any application featuring content presentation capabilities, such as, for example, a streaming video and/or audio presentation application, a broadcast video and/or audio presentation application, a DVD and/or Blue-Ray presentation application, a CD presentation application, a digital video file presentation application, a digital audio file presentation application, a conferencing application, a gaming application, a productivity application, a social networking application, a web browsing application, and so forth. While executing, content presentation application 105 may be operative to present video and/or audio content such as streaming video and/or audio, broadcast video and/or audio, video and/or audio content contained on a disc or other removable storage medium, and/or video and/or audio content contained in a digital video file and/or digital audio file. The embodiments, however, are not limited in this respect.

In some embodiments, apparatus 100 may comprise a content management module 106. Content management module 106 may comprise logic, circuitry, information, and/or instructions operative to manage the presentation of video and/or audio content. In various embodiments, content management module 106 may comprise programming logic or instructions within content presentation application 105 and/or stored in memory unit 104. In other embodiments, content management module 106 may comprise logic, circuitry, information, and/or instructions external to content presentation application 105, such as a driver, a chip and/or integrated circuit, or programming logic within another application or an operating system. The embodiments are not limited in this context.

FIG. 1 also illustrates a block diagram of a system 140. System 140 may comprise any of the aforementioned elements of apparatus 100. System 140 may further comprise a transceiver 144. Transceiver 144 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 144 may operate in accordance with one or more applicable standards in any version. The embodiments are not limited in this context.

In some embodiments, apparatus 100 and/or system 140 may be configurable to communicatively couple with one or more content presentation devices 142-n. Content presentation devices 142-n may comprise any devices capable of presenting video and/or audio content. Examples of content presentation devices 142-n may include displays capable of displaying information received from processor circuit 102, such as a television, a monitor, a projector, and a computer screen. In one embodiment, for example, a content presentation device 142-n may comprise a display implemented by a liquid crystal display (LCD), light emitting diode (LED) or other type of suitable visual interface, and may comprise one or more thin-film transistors (TFT) LCDs including embedded transistors. Examples of content presentation devices 142-n may also include audio playback devices and/or systems capable of generating tones, music, speech, speech utterances, sound effects, background noise, or other sounds, such as a speaker, a multi-speaker system, and/or a home entertainment system. Examples of content presentation devices 142-n may further include devices capable of playing back both video and audio, such as devices comprising both display components and audio playback components. Thus examples of content presentation devices 142-n may further include devices such as a television, a computer system, a mobile device, a portable electronic media device, and/or a consumer appliance. The embodiments are not limited to these examples.

In various embodiments, apparatus 100 may comprise or be arranged to communicatively couple with an input device 143. Input device 143 may be implemented using any device that enables apparatus 100 to receive user inputs. Examples of input device 143 may include a remote control, a mouse, a touch pad, a speech recognition device, a joystick, and/or a keyboard. In some embodiments, a content presentation device 142-n may comprise a display arranged to display a graphical user interface operable to directly or indirectly control content presentation application 105. In various such embodiments, the graphical user interface may be manipulated according to control inputs received via input device 143. The embodiments are not limited in this context.

In general operation, apparatus 100 and/or system 140 may be operative to implement and/or manage the presentation of a content item 150 on one or more content presentation devices 142-n. More particularly, apparatus 100 and/or system 140 may be operative to implement techniques for enhanced seek during consumption of content item 150. In some embodiments, content item 150 may comprise video content, audio content, and/or a combination of both. Some examples of content item 150 may include a motion picture, a play, a skit, a newscast, sporting event, or other television program, an image sequence, a video capture, a musical composition, a song, a soundtrack, an audio book, a podcast, a speech, and/or a spoken composition. The embodiments are not limited to these examples. In various embodiments, content item 150 may be comprised within a video and/or audio stream accessible by apparatus 100 and/or system 140, within information on a removable storage medium such as a CD, DVD, or Blu-Ray disc, within a digital video and/or audio file stored in memory unit 104 or in an external storage device, and/or within broadcast information received via transceiver 144. The embodiments are not limited to these examples.

In various embodiments, content management module 106 may be operative on a content presentation device 142-n to present a content item 150 according to a playback presentation mode. A playback presentation mode may comprise a presentation mode according to which content item 150 is presented on content presentation device 142-n at a standard or normal presentation rate, at which the content item 150 is intended to be consumed. For example, in a playback presentation mode with respect to a content item 150 comprising a recorded speech, the recorded speech may be presented at a presentation rate equal to the actual speaking rate of the speaker. In another example, in a playback presentation mode with respect to a content item 150 comprising a motion picture, the motion picture may be presented at a presentation rate matching that at which the motion picture is presented in theaters. In various embodiments, a playback presentation mode may comprise a “Play” mode. The embodiments are not limited in this context.

In some embodiments, in order to present a content item 150 on a content presentation device 142-n according to a playback presentation mode, content management module 106 may be operative to generate playback presentation information 108. Playback presentation information 108 may comprise data, information, or logic operative on the content presentation device 142-n to present the visual and/or auditory effects associated with content item 150 at the standard presentation rate according to the playback presentation mode. The embodiments are not limited in this context.

In some embodiments, apparatus 100 and/or system 140, or a device external thereto, may be operative to define time index values 152-q for content item 150. Each time index value 152-q may correspond to a portion of content item 150 that is to be presented at a particular point in time relative to the start of content playback when content item 150 is presented from start to finish in a playback presentation mode. For example, if content item 150 is a motion picture, a particular time index value 152-q associated with content item 150 that has a value equal to five seconds may correspond to visual effects and/or sounds that are presented when five seconds have elapsed from the start of ongoing presentation in a playback presentation mode. In various embodiments, time index values 152-q may have an associated granularity that defines an incremental amount of time by which each subsequent time index value 152-q exceeds its previous time index value 152-q. For example, time index values 152-q may have an associated granularity of 1/100^{th} of a second. In such an example, a first time index value 152-q associated with a particular content item 150 may have a value (in h:mm:ss.ss format) of 0:00:00.00, a second time index value 152-q may have value of 0:00:00.01, a third time index value may have a value of 0:00:00.02, and so forth. The embodiments are not limited to these examples.

In some embodiments, one or more events 154-r may be identified and/or defined that correspond to noteworthy occurrences and/or effects within content item 150. Examples of events 154-r may include, without limitation, lines of dialog, the entry and/or exit of characters and/or actors on screen or into a video or audio scene, scene changes, screen fades, beginnings and/or endings of songs or audio effects, plot developments, the beginning and/or endings of chapters, and any other occurrences or audio and/or visual effects. Each event 154-r in a particular content item 150 may occur or commence at, or most near to, a particular time index value 152-q, and thus may be regarded as corresponding to that time index value 152-q. For example, an event 154-r that comprises the entry of a character onto the screen in a content item 150 comprising a motion picture at time index value 0:51:45.35 may be regarded as corresponding to the time index value 0:51:45.35. Similarly, an event 154-r that comprises a particular line of dialog in a content item 150 comprising an audio book at time index value 0:21:33.75 may be regarded as corresponding to the time index value 0:21:33.75. Information identifying a particular event 154-r may be used to determine a particular time index value 152-q, based on the correspondence of the event 154-r to the time index value 152-q. In some embodiments, when a content item 150 is presented according to a playback presentation mode, the amount of real time that elapses between the presentation of any particular event 154-r and any other particular event 154-r in the content item 150 may be equal to the difference between the time index values 152-q associated with those particular events 154-r. The embodiments are not limited in this context.

In some embodiments, content management module 106 may be operative on a content presentation device 142-n to present a content item 150 according to a seek presentation mode. A seek presentation mode may comprise a presentation mode according to which content item 150 is presented on content presentation device 142-n at a presentation rate that differs from a standard or normal presentation rate at which the content item 150 is intended to be consumed. In some seek presentation modes, such as a fast forward mode, a content item 150 may be presented at a presentation rate that exceeds the standard presentation rate. In some seek presentation modes, such as a rewind mode, a content item 150 may be presented at a presentation rate that exceeds the standard presentation rate and in a reverse direction with respect to time, such that events 154-r are presented in reverse order with respect to their time index values 152-q. In some seek presentation modes, such as a slow-motion forward or reverse mode, a content item 150 may be presented at a presentation rate that is lower than the standard presentation rate. In some seek presentation modes, some elements of content item 150 may be omitted from presentation in order to improve the quality of the user experience during those presentation modes. For example, in a seek presentation mode comprising a rewind mode with respect to a motion picture, audio elements of the motion picture may be omitted from presentation, because they would be garbled and/or unintelligible when presented backwards according to the rewind mode. In another example, in a seek presentation mode comprising a fast forward mode with respect to such a motion picture, individual frames of the motion picture may be skipped. The embodiments are not limited to these examples.

In some embodiments, in order to present a content item 150 on a content presentation device 142-n according to a seek presentation mode, content management module 106 may be operative to generate seek presentation information 109. Seek presentation information 109 may comprise data, information, or logic operative on the content presentation device 142-n to present the visual and/or auditory effects associated with content item 150 at a presentation rate that differs from the standard presentation rate, according to the seek presentation mode. The embodiments are not limited in this context.

In various embodiments, a consumer of a content item 150 may initiate a seek presentation mode in order to locate an event 154-r that is of interest, to identify a time index value 152-q from which he wishes to initiate a playback presentation mode, to consume content item 150 at a faster or slower rate, or simply to move forward or backwards within content item 150 by an amount of time that is non-specific (from the perspective of that consumer). For example, a consumer of a content item 150 comprising a motion picture may initiate a seek presentation mode in order to locate a beginning of a particular scene, to reach a time index value 152-q at which he previously left off, to view the motion picture at a reduced rate in order to more readily analyze the visual effects of a scene, or to advance past scenes that he does not wish to view. The embodiments are not limited to these examples.

In some embodiments, during presentation of a content item 150 according to either a playback presentation mode or a seek presentation mode, content management module 106 may be operative to maintain a time index counter 110. More particularly, content item 150 may maintain time index counter 110 such that at each particular point during content presentation, the visual and/or auditory effects presented on a content presentation device 142-n correspond to those comprised within the content item 150 at a time index value 152-q equal to the time index counter 110. The embodiments are not limited in this context.

In conventional systems, when a content item 150 is presented according to a seek presentation mode, the ability of a consumer of the content item 150 to understand the significance of the presented visual and/or auditory effects may be diminished, due to the deviation of the presentation rate from the intended consumption rate and/or due to the omissions of elements of the content item 150 from the presentation. For example, if a content item 150 comprising a motion picture is presented in a fast forward mode with the audio omitted, a consumer of the content item 150 according to the fast forward mode may have difficulty determining which characters are on-screen, and may be unaware of the lines of dialog spoken by those characters. As a result, the consumer may be unable to keep track of where the presented content lies within the plot chronology of the motion picture.

In order to address these shortcomings, in various embodiments, the presentation of a content item 150 according to a seek presentation mode may be enhanced using content description information 114-s-1. More particularly, during presentation of a content item 150 in a seek presentation mode, content management module 106 may be operative to determine content description information 114-s-1 corresponding to time index counter 110 and generate seek presentation information 109 comprising the content description information 114-s-1. The seek presentation information 109 may be operative on a content presentation device 142-n to present the content description information 114-s-1 with the visual and/or auditory effects of the content item 150 corresponding to a time index value 152-q equal to the time index counter 110. The embodiments are not limited in this context.

In some embodiments, content description information 114-s-1 may comprise information describing one or more events 154-r with corresponding time index values 152-q equal to time index counter 110. In various embodiments, content management module 106 may be operative to determine content description information 114-s-1 by accessing a content description database 112. Content description database 112 may comprise one or more content description database entries 114-s, each of which may comprise content description information 114-s-1 and event-time correspondence information 114-s-2. Content description information 114-s-1 may comprise information identifying particular events 154-r and/or characteristics associated with those events 154-r. For example, content description information 114-s-1 may comprise information identifying an event 154-r comprising a particular line of dialog, and may comprise information identifying a character uttering that line of dialog and the words spoken thereby. Event-time correspondence information 114-s-2 may comprise information identifying a time index value 152-q corresponding to the event 154-r identified by the content description information 114-s-1. For example, event-time correspondence information 114-s-2 may comprise information identifying a time index value 152-q corresponding to an event 154-r comprising a line of dialog. The embodiments are not limited to these examples.

It is worthy of note that although content description database 112 is illustrated in FIG. 1 as being external to apparatus 100, system 140, and content item 150, the embodiments are not so limited. It is also worthy of note that content description database 112 and content item 150 need not necessarily be stored or reside at the same location. In some embodiments, either content item 150, content description database 112, or both may be stored in memory unit 104, stored on an external removable storage medium such as a DVD, stored on an external non-removable storage medium such as a hard drive, or stored at a remote location and accessible over one or more wired and/or wireless network connections. In an example embodiment, content item 150 may comprise a motion picture stored on a DVD, content description database 112 may be stored on that same DVD, and apparatus 100 and/or system 140 may be operative to access both content item 150 and content description database 112 by accessing that DVD. In another example embodiment, content item 150 may comprise a motion picture stored on a DVD, and content description database 112 may reside on a remote server and may be accessible via one or more wired and/or wireless network connections. In yet another example embodiment, content item 150 may comprise a motion picture stored on a remote server and accessible via one or more wired and/or wireless network connections, and content description database 112 may be stored in memory unit 104. In still another example embodiment, both content item 150 and content description database 112 may reside on a remote server and may be accessible via one or more wired and/or wireless network connections. The embodiments are not limited to these examples.

It is further worthy of note that in various embodiments, rather than accessing content description database 112 from an external source, apparatus 100 and/or system 140 may be operative to generate content description database 112 by processing content item 150 and/or content metadata elements associated with content item 150. For example, content management module 106 may be operative to generate a content description database 112 for a content item 150 comprising a motion picture by processing content metadata elements comprising a subtitle information file for the content item 150. Further, in some embodiments, some or all of content description information 114-s-1 may not correspond to any particular event(s) 154-r, but instead may simply describe characteristics of visual and/or auditory effects associated with content item 150. For example, particular content description information 114-s-1 may comprise, for a given time index value 152-q, a count of a number of characters present on screen, or an indication of whether it is night or day at a point in the narrative corresponding to the time index value 152-q. The embodiments are not limited to these examples.

In various embodiments, content management module 106 may be operative to receive an instruction to initiate a seek presentation mode for a content item 150. In some such embodiments, a consumer may provide via input device 143 an input comprising an instruction to initiate a seek presentation mode, and content management module 106 may receive the instruction from input device 143. The embodiments are not limited in this context.

In some embodiments, content management module 106 may be operative to determine content description information 114-s-1 for a portion of the content item 150. In various such embodiments, the portion of the content item 150 may comprise time index values 152-q that are equal to time index counter 110, that are within a certain range about time index counter 110, or that satisfy some other defined criteria with respect to time index counter 110. In some embodiments, content management module 106 may be operative to search content description database 112 for content description database entries 114-s comprising event-time correspondence information 114-s-2 identifying time index values 152-q that are equal to time index counter 110, that are within a certain range about time index counter 110, or that satisfy some other defined criteria with respect to time index counter 110. For example, content management module 106 may be operative to search content description database 112 for content description database entries 114-s comprising event-time correspondence information 114-s-2 identifying time index values 152-q that are within five seconds of time index counter 110. In various embodiments, alternatively or additionally to obtaining content description information 114-s-1 from content description database 112, content management module 106 may be operative to generate content description information 114-s-1 for the portion of the content item 150 by processing the content item 150. The embodiments are not limited in this context.

In various embodiments, content management module 106 may be operative to generate seek presentation information 109 comprising the content description information 114-s-1 of any content description database entries 114-s comprising event-time correspondence information 114-s-2 identifying time index values 152-q that satisfy the defined criteria with respect to time index counter 110. Additionally or alternatively, the seek presentation information 109 may comprise content description information 114-s-1 generated by content management module 106 in processing the content item 150. In an example embodiment, the content description information 114-s-1 in seek presentation information 109 may comprise both a line of dialog retrieved from a content description database entry 114-s in content description database 112 and a count of a number of characters on screen obtained by content management module 106 in processing content item 150. The embodiments are not limited in this context.

In some embodiments, content management module 106 may be operative to transmit the seek presentation information 109 to a content presentation device 142-n, and the seek presentation information 109 may be operative on the content presentation device 142-n to present the content item 150 in the seek presentation mode. In various such embodiments, the content presentation device 142-n may comprise a display 142-n-1, and the seek presentation information 109 may be operative on the content presentation device 142-n to present one or more content description display elements 155-t on the display 142-n-1 based on the content description information 114-s-1. The one or more content description display elements 155-t may comprise visual effects rendered on the display 142-n-1 that depict the content description information 114-s-1. In some embodiments, the seek presentation information 109 may be operative on the content presentation device 142-n to present the one or more content description display elements 155-t on the display 142-n-1 during the a presentation of the portion of the content item 150 on the content presentation device. In an example embodiment, a content description display element 155-t may comprise a printout of a line of dialog obtained from subtitle information in content description database 112, and superimposed on a content item 150 comprising a motion picture when that line of dialog is spoken. In another example embodiment, a content description display element 155-t may comprise an information box identifying a character appearing on screen in the motion picture, and may be presented when that character appears on screen. In these examples and in various other embodiments, presenting the content description display elements 155-t in the seek presentation mode may allow viewers to remain aware of dialog and/or plot developments in content items 150 even while consuming those content items 150 at a non-standard presentation rate. The embodiments are not limited in this context.

It is worthy of note that content description display elements 155-t may be generated and presented on display 142-n-1 even for content items 150 that are non-visual in nature. For example, during presentation in a seek presentation mode of a content item 150 comprising an audio book, content description information 114-s-1 may be determined, generated, or retrieved that identifies characters within a portion of the audio book. That content description information 114-s-1 may then be presented in content description display elements 155-t on display 142-n-1 while the auditory effects associated with the portion of the audio book are presented at an accelerated rate by the content presentation device 142-n comprising the display 142-n-1. The embodiments are not limited to this example.

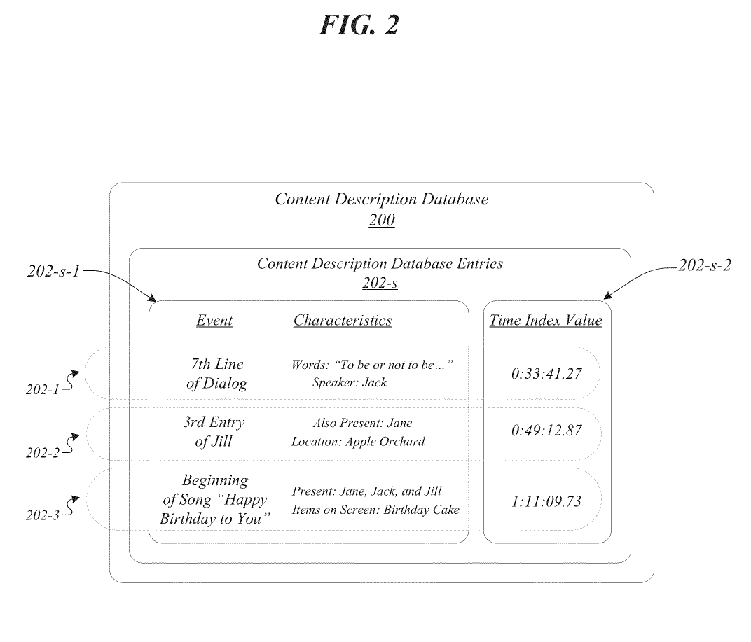

FIG. 2 illustrates one embodiment of a content description database 200 such as may be comprised by content description database 112 of FIG. 1. As shown in FIG. 2, content description database 200 comprises content description database entries 202-s, which in turn comprise content description information 202-s-1 and event-time correspondence information 202-s-2. For example, content description database entry 202-1 comprises content description information 202-1-1 identifying an event comprising a seventh line of dialog, and indicates that this line of dialog is spoken by the character Jack and comprises the words “to be or not to be . . . ” Content description database entry 202-1 also comprises event-time correspondence information 202-1-2 indicating that the event identified by content description information 202-1-1 occurs at time index value 0:33:41.27. The embodiments are not limited to the examples in FIG. 2.

In an example embodiment, with reference to FIGS. 1 and 2, content management module 106 of FIG. 1 may be operative to receive an instruction to initiate a seek presentation mode for a content item 150 to which content description database 200 of FIG. 2 corresponds. Content management module 106 may then access content description database 200 and search for content description database entries 202-s comprising time index values 202-s-2 within a range of five seconds of time index counter 110. Time index counter 110 may be equal to 0:33:40.00, and content management module 106 may determine that time index value 202-1-2 within content description database entry 202-1 is equal to 0:33:41.27, and is thus within the range of five seconds of time index counter 110. Based on this determination, content management module 106 may be operative to retrieve content description information 202-1-1 comprising the line of dialog “No be or not to be . . . ” from content description database entry 202-1, and generate seek presentation information 109 based on this content description information 202-1-1. The seek presentation information 109 may be operative on a content presentation device 142-n comprising a display 142-n-1 to present a content description display element 155-t comprising the line of dialog “No be or not to be . . . ” during presentation of the content item 150 on the content presentation device 142-n according to the seek presentation mode. The embodiments are not limited to this example.

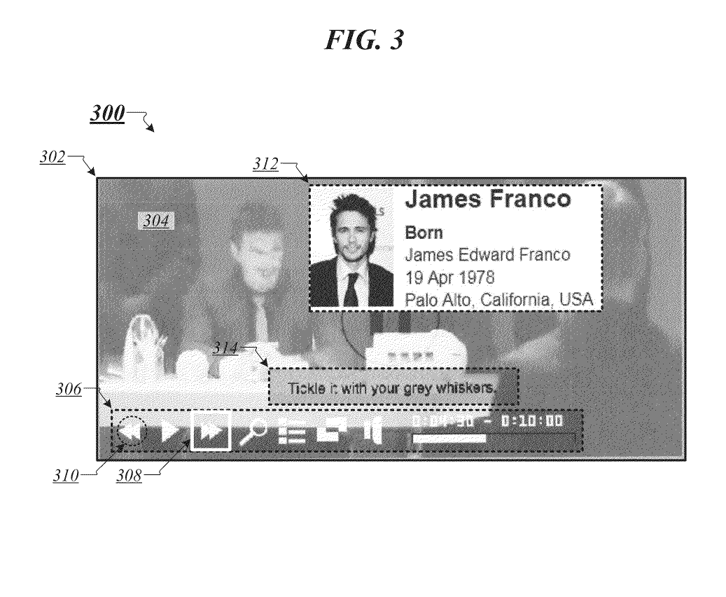

FIG. 3 illustrates one embodiment of a content item presentation 300. More particularly, FIG. 3 illustrates an example of a screen capture such as may be acquired during presentation of a content item 150 in a seek presentation mode according to various embodiments. As shown in FIG. 3, content item presentation 300 comprises a content presentation window 302, such as may correspond to a screen of a display 142-n-1 in a content presentation device 142-n of FIG. 1. Displayed in content presentation window 302 are visual effects 304 which may comprise an example of visual effects associated with a portion of a content item 150 of FIG. 1. For example, visual effects 304 may comprise visual effects of a content item 150 with a particular corresponding time index value 152-1, such that they will be displayed in content presentation window 302 when time index counter 110 is equal to time index value 152-1. In various embodiments, such presentation of visual effects 304 may occur during a playback presentation mode as well as during a seek presentation mode. Also displayed in content presentation window 302 is a graphical user interface 306 such as may be presented by a content presentation device 142-n of FIG. 1 in order to directly or indirectly control content presentation application 105. In various embodiments, inputs entered into an input device such as input device 143 of FIG. 1 may be processed in conjunction with one or more control elements in graphical user interface 306 to generate one or more instructions for content presentation application 105 and/or content management module 106. For example, a user may enter input into an input device 143 to move a selection focus 308 onto rewind element 310 in graphical user interface 306. The user may then enter input into the input device 143 to select the rewind element 310, and thus send an instruction to content management module 106 to initiate a seek presentation mode for a content item 150 being presented in content presentation window 302. The embodiments are not limited to this example.

Further displayed in content presentation window 302 are content description display elements 312 and 314, which may comprise examples of content description display elements 155-t such as may be presented on a display 142-n-1 in a content presentation device 142-n of FIG. 1. In various embodiments, information within content description display elements such as content description display elements 312 and 314 of FIG. 3 may comprise content description information 114-s-1 associated with a portion of a content item such as content item 150 of FIG. 1. In the example of FIG. 3, content description display element 312 comprises an information box identifying an actor—James Franco—that appears in a portion of a content item depicted by visual effects 304. Content description display element 312 also comprises biographical information regarding the actor identified therein. For example, content description display element 312 indicates that James Franco was born on Apr. 19, 1978. Content description display element 314 comprises a printout of a line of dialog, such as may correspond to the portion of the content item depicted by visual effects 304. In various embodiments, a content description display element such as content description display element 314 may display a line of dialog with a time index value 152-q equal to a time index counter 110 value associated with visual effects 304. As such, the line of dialog may be presented in content description display element 314 when the portion of the content item in which it is spoken is being depicted by visual effects 304. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

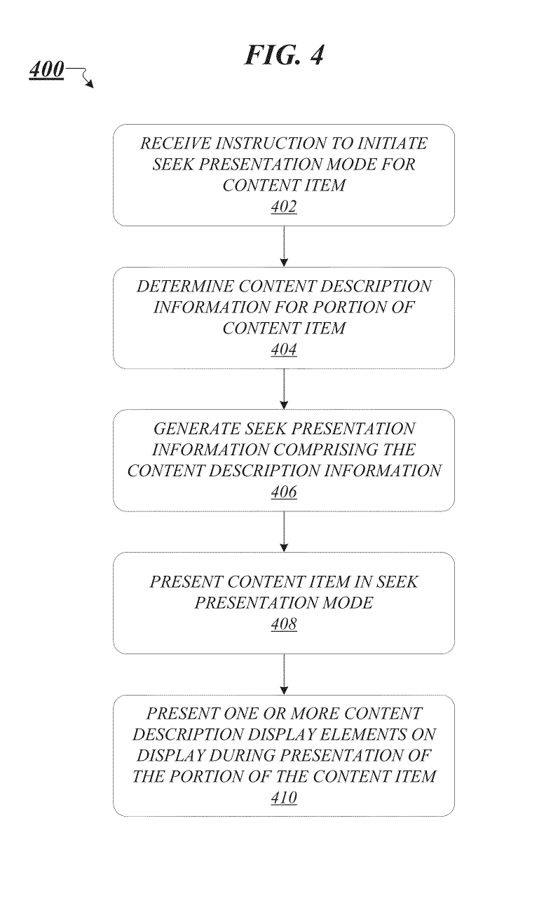

FIG. 4 illustrates one embodiment of a logic flow 400, which may be representative of the operations executed by one or more embodiments described herein. As shown in logic flow 400, an instruction to initiate a seek presentation mode for a content item may be received at 402. For example, content management module 106 of FIG. 1 may receive an instruction to initiate a seek presentation mode for a content item 150. At 404, content description information for a portion of the content item may be determined. For example, content management module 106 of FIG. 1 may determine content description information 114-s-1 for a portion of the content item 150 based on one or more content description database entries 114-s in content description database 112. At 406, seek presentation information comprising the content description information may be generated. For example, content management module 106 of FIG. 1 may generate seek presentation information 109 comprising the content description information 114-s-1. In various embodiments, the content management module may be operative to transmit the seek presentation information to a content presentation device comprising a display. For example, content management module 106 of FIG. 1 may transmit seek presentation information 109 to a content presentation device 142-n comprising a display 142-n-1. At 408, the content item may be presented in a seek presentation mode. For example, a content presentation device 142-n of FIG. 1 may be operative to present the content item 150 in a seek presentation mode based on seek presentation information 109. At 410, one or more content description display elements may be presented on a display during presentation of the portion of the content item in the seek presentation mode. For example, a display 142-n-1 in a content presentation device 142-n of FIG. 1 may present one or more content description display elements 155-t during presentation of a portion of content item 150 in a seek presentation mode. The embodiments are not limited to these examples.

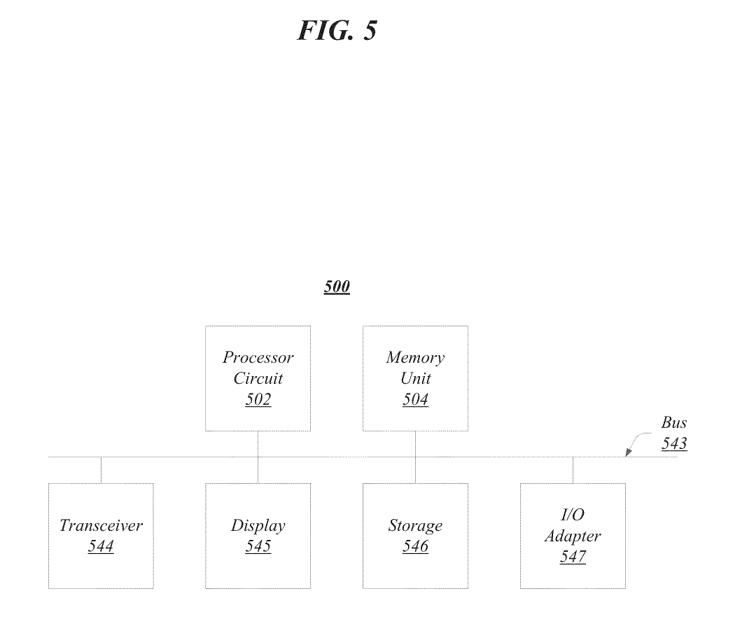

FIG. 5 illustrates one embodiment of a system 500. In various embodiments, system 500 may be representative of a system or architecture suitable for use with one or more embodiments described herein, such as apparatus 100 and/or system 140 of FIG. 1 and/or logic flow 400 of FIG. 4. The embodiments are not limited in this respect.

As shown in FIG. 5, system 500 may include multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In various embodiments, system 500 may include a processor circuit 502. Processor circuit 502 may be implemented using any processor or logic device, and may be the same as or similar to processor circuit 102 of FIG. 1.

In one embodiment, system 500 may include a memory unit 504 to couple to processor circuit 502. Memory unit 504 may be coupled to processor circuit 502 via communications bus 543, or by a dedicated communications bus between processor circuit 502 and memory unit 504, as desired for a given implementation. Memory unit 504 may be implemented using any machine-readable or computer-readable media capable of storing data, including both volatile and non-volatile memory, and may be the same as or similar to memory unit 104 of FIG. 1. In some embodiments, the machine-readable or computer-readable medium may include a non-transitory medium. The embodiments are not limited in this context.

In various embodiments, system 500 may include a transceiver 544. Transceiver 544 may include one or more radios capable of transmitting and receiving signals using various suitable wireless communications techniques, and may be the same as or similar to transceiver 144 of FIG. 1.

In various embodiments, system 500 may include a display 545. Display 545 may constitute any display device capable of displaying information received from processor circuit 502. Examples for display 545 may include a television, a monitor, a projector, and a computer screen. In one embodiment, for example, display 545 may be implemented by a liquid crystal display (LCD), light emitting diode (LED) or other type of suitable visual interface. Display 545 may constitute, for example, a touch-sensitive color display screen. In various implementations, display 545 may include one or more thin-film transistors (TFT) LCD including embedded transistors. In various embodiments, display 545 may be arranged to display a graphical user interface operable to directly or indirectly control a graphics processing application, such as content presentation application 105 in FIG. 1, for example. In some embodiments, display 545 may be comprised within a content presentation device such as content presentation device 142-n of FIG. 1. The embodiments are not limited in this context.

In various embodiments, system 500 may include storage 546. Storage 546 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 546 may include technology to increase the storage performance enhanced protection for valuable digital media when multiple hard drives are included, for example. Further examples of storage 546 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 500 may include one or more I/O adapters 547. Examples of I/O adapters 547 may include Universal Serial Bus (USB) ports/adapters, IEEE 1394 Firewire ports/adapters, and so forth. The embodiments are not limited in this context.

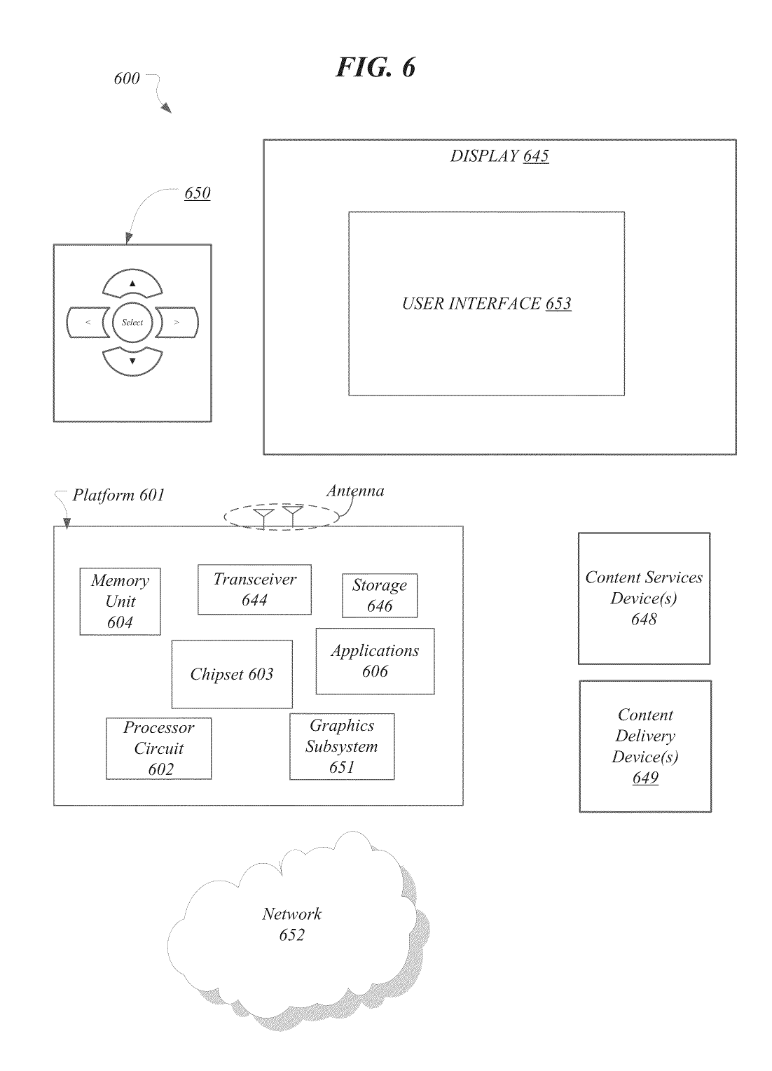

FIG. 6 illustrates an embodiment of a system 600. In various embodiments, system 600 may be representative of a system or architecture suitable for use with one or more embodiments described herein, such as apparatus 100 and/or system 140 of FIG. 1, logic flow 400 of FIG. 4, and/or system 500 of FIG. 5. The embodiments are not limited in this respect.

As shown in FIG. 6, system 600 may include multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in system 600 as desired for a given implementation. The embodiments are not limited in this context.

In embodiments, system 600 may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 600 includes a platform 601 coupled to a display 645. Platform 601 may receive content from a content device such as content services device(s) 648 or content delivery device(s) 649 or other similar content sources. A navigation controller 650 including one or more navigation features may be used to interact with, for example, platform 601 and/or display 645. Each of these components is described in more detail below.

In embodiments, platform 601 may include any combination of a processor circuit 602, chipset 603, memory unit 604, transceiver 644, storage 646, applications 651, and/or graphics subsystem 652. Chipset 603 may provide intercommunication among processor circuit 602, memory unit 604, transceiver 644, storage 646, applications 651, and/or graphics subsystem 652. For example, chipset 603 may include a storage adapter (not depicted) capable of providing intercommunication with storage 646.

Processor circuit 602 may be implemented using any processor or logic device, and may be the same as or similar to processor circuit 502 in FIG. 5.

Memory unit 604 may be implemented using any machine-readable or computer-readable media capable of storing data, and may be the same as or similar to memory unit 504 in FIG. 5.

Transceiver 644 may include one or more radios capable of transmitting and receiving signals using various suitable wireless communications techniques, and may be the same as or similar to transceiver 544 in FIG. 5.

Display 645 may include any television type monitor or display, and may be the same as or similar to display 545 in FIG. 5.

Storage 646 may be implemented as a non-volatile storage device, and may be the same as or similar to storage 546 in FIG. 5.

Graphics subsystem 652 may perform processing of images such as still or video for display. Graphics subsystem 652 may be a graphics processing unit (GPU) or a visual processing unit (VPU), for example. An analog or digital interface may be used to communicatively couple graphics subsystem 652 and display 645. For example, the interface may be any of a High-Definition Multimedia Interface, DisplayPort, wireless HDMI, and/or wireless HD compliant techniques. Graphics subsystem 652 could be integrated into processor circuit 602 or chipset 603. Graphics subsystem 652 could be a stand-alone card communicatively coupled to chipset 603.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 648 may be hosted by any national, international and/or independent service and thus accessible to platform 601 via the Internet, for example. Content services device(s) 648 may be coupled to platform 601 and/or to display 645. Platform 601 and/or content services device(s) 648 may be coupled to a network 653 to communicate (e.g., send and/or receive) media information to and from network 653. Content delivery device(s) 649 also may be coupled to platform 601 and/or to display 645.

In embodiments, content services device(s) 648 may include a cable television box, personal computer, network, telephone, Internet enabled devices or appliance capable of delivering digital information and/or content, and any other similar device capable of unidirectionally or bidirectionally communicating content between content providers and platform 601 and/display 645, via network 653 or directly. It will be appreciated that the content may be communicated unidirectionally and/or bidirectionally to and from any one of the components in system 600 and a content provider via network 653. Examples of content may include any media information including, for example, video, music, medical and gaming information, and so forth.

Content services device(s) 648 receives content such as cable television programming including media information, digital information, and/or other content. Examples of content providers may include any cable or satellite television or radio or Internet content providers. The provided examples are not meant to limit embodiments of the invention.

In embodiments, platform 601 may receive control signals from navigation controller 650 having one or more navigation features. The navigation features of navigation controller 650 may be used to interact with a user interface 654, for example. In embodiments, navigation controller 650 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 650 may be echoed on a display (e.g., display 645) by movements of a pointer, cursor, focus ring, or other visual indicators displayed on the display. For example, under the control of software applications 651, the navigation features located on navigation controller 650 may be mapped to virtual navigation features displayed on user interface 654. In embodiments, navigation controller 650 may not be a separate component but integrated into platform 601 and/or display 645. Embodiments, however, are not limited to the elements or in the context shown or described herein.

In embodiments, drivers (not shown) may include technology to enable users to instantly turn on and off platform 601 like a television with the touch of a button after initial boot-up, when enabled, for example. Program logic may allow platform 601 to stream content to media adaptors or other content services device(s) 648 or content delivery device(s) 649 when the platform is turned “off.” In addition, chip set 603 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 600 may be integrated. For example, platform 601 and content services device(s) 648 may be integrated, or platform 601 and content delivery device(s) 649 may be integrated, or platform 601, content services device(s) 648, and content delivery device(s) 649 may be integrated, for example. In various embodiments, platform 601 and display 645 may be an integrated unit. Display 645 and content service device(s) 648 may be integrated, or display 645 and content delivery device(s) 649 may be integrated, for example. These examples are not meant to limit the invention.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 601 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

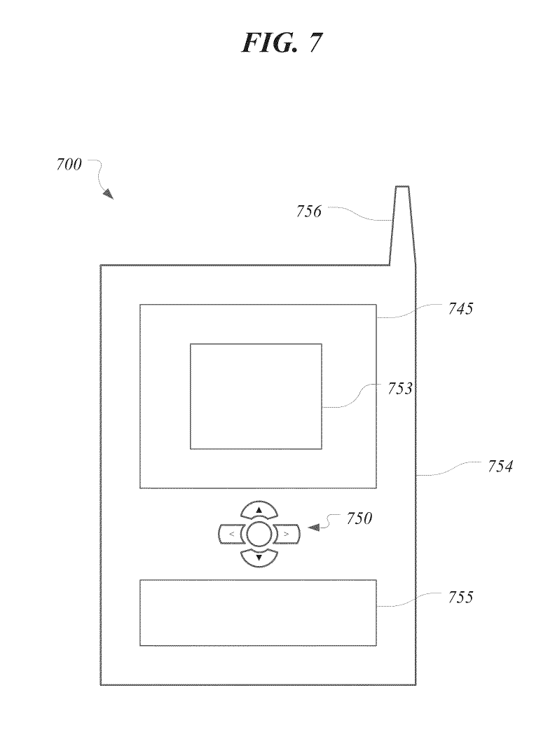

As described above, system 600 may be embodied in varying physical styles or form factors. FIG. 7 illustrates embodiments of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may include a display 745, a navigation controller 750, a user interface 754, a housing 755, an I/O device 756, and an antenna 757. Display 745 may include any suitable display unit for displaying information appropriate for a mobile computing device, and may be the same as or similar to display 645 in FIG. 6. Navigation controller 750 may include one or more navigation features which may be used to interact with user interface 754, and may be the same as or similar to navigation controller 650 in FIG. 6. I/O device 756 may include any suitable I/O device for entering information into a mobile computing device. Examples for I/O device 756 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

An apparatus may comprise a processor circuit and a memory unit communicatively coupled to the processor circuit and arranged to store a content management module operative to manage seek operations for a content item, and the content management module may be operative on the processor circuit to receive an instruction to initiate a seek presentation mode for the content item, determine content description information for an event within the content item, and generate seek presentation information comprising the content description information.

With respect to such an apparatus, the content management module may be operative to transmit the seek presentation information to a content presentation device comprising a display.

With respect to such an apparatus, the seek presentation information may be operative on the content presentation device to present the content item in the seek presentation mode.

With respect to such an apparatus, the seek presentation information may be operative on the content presentation device to present one or more content description display elements on the display based on the content description information during a presentation of the portion of the content item on the content presentation device.

With respect to such an apparatus, the content management module may be operative to receive an instruction to initiate a playback presentation mode for the content item, generate playback presentation information for the content item, and transmit the playback presentation information to the content presentation device, and the playback presentation information may be operative on the content presentation device to present the content item in the playback presentation mode.

With respect to such an apparatus, the seek presentation mode may comprise a backward seek mode or a forward seek mode.

With respect to such an apparatus, the instruction to initiate the seek presentation mode may comprise an input received by an input device communicatively coupled to the content management module.

With respect to such an apparatus, the content description information may comprise one or more lines of dialog.

With respect to such an apparatus, the content description information may identify one or more characters in a scene.

With respect to such an apparatus, the content description information may identify one or more actors in a scene.

A computer-implemented method may comprise receiving an instruction to initiate a seek presentation mode for a content item, determining, by a processor circuit, content description information for an event within the content item, and generating seek presentation information comprising the content description information.

Such a computer-implemented method may comprise transmitting the seek presentation information to a content presentation device comprising a display.

Such a computer-implemented method may comprise presenting the content item in the seek presentation mode.

Such a computer-implemented method may comprise presenting one or more content description display elements on the display based on the content description information during a presentation of the portion of the content item on the content presentation device.

Such a computer-implemented method may comprise receiving an instruction to initiate a playback presentation mode for the content item, generating playback presentation information for the content item, and transmitting the playback presentation information to the content presentation device, and the playback presentation information may be operative on the content presentation device to present the content item in the playback presentation mode.

With respect to such a computer-implemented method, the seek presentation mode may comprise a backward seek mode or a forward seek mode.

With respect to such a computer-implemented method, the instruction to initiate the seek presentation mode may comprise an input received by an input device communicatively coupled to the processor circuit.

With respect to such a computer-implemented method, the content description information may comprise one or more lines of dialog.

With respect to such a computer-implemented method, the content description information may identify one or more characters in a scene.

With respect to such a computer-implemented method, the content description information may identify one or more actors in a scene.

A communications device may be arranged to perform such a computer-implemented method.

At least one machine-readable medium may comprise instructions that, in response to being executed on a computing device, cause the computing device to carry out such a computer-implemented method.

An apparatus may comprise means for performing such a computer-implemented method.

At least one machine-readable medium may comprise instructions that, in response to being executed on a computing device, cause the computing device to receive an instruction to initiate a seek presentation mode for a content item, determine content description information for a portion of the content item, generate seek presentation information comprising the content description information, and transmit the seek presentation information to a content presentation device.

With respect to such at least one machine-readable medium, the content presentation device may comprise a display.

With respect to such at least one machine-readable medium, the seek presentation information may be operative on the content presentation device to present the content item in the seek presentation mode.

With respect to such at least one machine-readable medium, the seek presentation information may be operative on the content presentation device to present one or more content description display elements on the display based on the content description information during a presentation of the portion of the content item on the content presentation device.

Such at least one machine-readable medium may comprise instructions that, in response to being executed on the computing device, cause the computing device to receive an instruction to initiate a playback presentation mode for the content item, generate playback presentation information for the content item, and transmit the playback presentation information to the content presentation device, and the playback presentation information may be operative on the content presentation device to present the content item in the playback presentation mode.

With respect to such at least one machine-readable medium, the seek presentation mode may comprise a backward seek mode or a forward seek mode.

With respect to such at least one machine-readable medium, the instruction to initiate the seek presentation mode may comprise an input received by an input device communicatively coupled to the computing device.

With respect to such at least one machine-readable medium, the content description information may comprise one or more lines of dialog.

With respect to such at least one machine-readable medium, the content description information may identify one or more characters in a scene.

With respect to such at least one machine-readable medium, the content description information may identify one or more actors in a scene.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor circuit;
a memory unit communicatively coupled to the processor circuit and arranged to store a content management module operative to manage seek operations for a content item, the content management module operative on the processor circuit to:
receive an instruction to initiate a seek presentation mode for the content item;
determine content description information for an event within the content item; and
generate seek presentation information comprising the content description information.

2. The apparatus of claim 1, the content management module operative to transmit the seek presentation information to a content presentation device comprising a display.

3. The apparatus of claim 2, the seek presentation information operative on the content presentation device to present the content item in the seek presentation mode.

4. The apparatus of claim 3, the seek presentation information operative on the content presentation device to present one or more content description display elements on the display based on the content description information during a presentation of the portion of the content item on the content presentation device.

5. The apparatus of claim 2, the content management module operative to:
receive an instruction to initiate a playback presentation mode for the content item;
generate playback presentation information for the content item; and
transmit the playback presentation information to the content presentation device, the playback presentation information operative on the content presentation device to present the content item in the playback presentation mode.

6. The apparatus of claim 1, the seek presentation mode comprising a backward seek mode or a forward seek mode.

7. The apparatus of claim 1, the instruction to initiate the seek presentation mode comprising an input received by an input device communicatively coupled to the content management module.

8. The apparatus of claim 1, the content description information comprising one or more lines of dialog.

9. The apparatus of claim 1, the content description information identifying one or more characters in a scene.

10. The apparatus of claim 1, the content description information identifying one or more actors in a scene.

11. A computer-implemented method, comprising:
receiving an instruction to initiate a seek presentation mode for a content item;
determining, by a processor circuit, content description information for an event within the content item; and
generating seek presentation information comprising the content description information.

12. The computer-implemented method of claim 11, comprising transmitting the seek presentation information to a content presentation device comprising a display.

13. The computer-implemented method of claim 12, comprising presenting the content item in the seek presentation mode.

14. The computer-implemented method of claim 13, comprising presenting one or more content description display elements on the display based on the content description information during a presentation of the portion of the content item on the content presentation device.

15. The computer-implemented method of claim 12, comprising:
receiving an instruction to initiate a playback presentation mode for the content item;
generating playback presentation information for the content item; and
transmitting the playback presentation information to the content presentation device, the playback presentation information operative on the content presentation device to present the content item in the playback presentation mode.

16. The computer-implemented method of claim 11, the seek presentation mode comprising a backward seek mode or a forward seek mode.

17. The computer-implemented method of claim 11, the instruction to initiate the seek presentation mode comprising an input received by an input device communicatively coupled to the processor circuit.

18. The computer-implemented method of claim 11, the content description information comprising one or more lines of dialog.

19. The computer-implemented method of claim 11, the content description information identifying one or more characters in a scene.

20. The computer-implemented method of claim 11, the content description information identifying one or more actors in a scene.

21. At least one machine-readable medium comprising a plurality of instructions that, in response to being executed on a computing device, cause the computing device to:
receive an instruction to initiate a seek presentation mode for a content item;
determine content description information for a portion of the content item;
generate seek presentation information comprising the content description information; and
transmit the seek presentation information to a content presentation device.

22. The at least one machine-readable medium of claim 21, the content presentation device comprising a display.

23. The at least one machine-readable medium of claim 22, the seek presentation information operative on the content presentation device to present the content item in the seek presentation mode.

24. The at least one machine-readable medium of claim 23, the seek presentation information operative on the content presentation device to present one or more content description display elements on the display based on the content description information during a presentation of the portion of the content item on the content presentation device.

25. The at least one machine-readable medium of claim 22, comprising instructions that, in response to being executed on the computing device, cause the computing device to:
receive an instruction to initiate a playback presentation mode for the content item;
generate playback presentation information for the content item; and
transmit the playback presentation information to the content presentation device, the playback presentation information operative on the content presentation device to present the content item in the playback presentation mode.

26. The at least one machine-readable medium of claim 21, the seek presentation mode comprising a backward seek mode or a forward seek mode.

27. The at least one machine-readable medium of claim 21, the instruction to initiate the seek presentation mode comprising an input received by an input device communicatively coupled to the computing device.

28. The at least one machine-readable medium of claim 21, the content description information comprising one or more lines of dialog.

29. The at least one machine-readable medium of claim 21, the content description information identifying one or more characters in a scene.

30. The at least one machine-readable medium of claim 21, the content description information identifying one or more actors in a scene.
